(19) United States
(12) Patent Application Publication
(10) Pub. No.: US 2011/0032098 A1
(43) Pub. Date: Feb. 10, 2011

(54) Portable electronic apparatus with a user physical status sensing and warning circuit

(76) Inventor: Cheng-Yun Yang, Hsin Tien City (TW)

Correspondence Address: BACON & THOMAS, PLLC, 625 SLATERS LANE, FOURTH FLOOR, ALEXANDRIA, VA, 22314-1176, US

(21) Appl. No.: 12/461,281

(22) Filed: Aug. 6, 2009

(51) Int. Cl. G08B 21/00

(52) U.S. Cl. 340/540

(57) ABSTRACT

An portable electronic apparatus is disclosed having a sensor module adapted for sensing the user's physical status, a memory unit having stored therein predetermined configuration status data, an alarm, and a microcontroller for driving the sensor module to detect the user's physical status, comparing the detected physical status data to the configuration status data stored in the memory unit, determining the detected physical status data to be an abnormal physical status when the comparison result matches, and driving the alarm to produce a warning signal when an abnormal physical status is determined.

### BACKGROUND OF THE INVENTION

1. Field of the Invention

The present invention relates to portable electronic apparatus and more particularly, to a portable electronic apparatus with a user physical status sensing and warning circuit that detects the user's physical status and gives a warning signal to alert the user when the user's physical status is abnormal.

2. Description of the Related Art

Following fast development of the prosperity of humankind and increase of personal income and rise in consuming power, people's pace of life is getting faster. In consequence, many people use a car or motorcycle as personal transportation vehicle instead of taking a mass transportation vehicle, thereby saving much traveling time and enhancing mobility. Nowadays, traffic jams and traffic accidents are frequently seen in every city. When one is getting tired, listening to a music or operating a mobile telephone as he (she) is driving a car or riding a motorcycle, an accident may occur.

To improve car-driving/motorcycle-riding safety and to lower the occurrence of traffic accidents, for example, hand-free Bluetooth earphone sets are created for use with a mobile telephone or a car stereo system. However, these Bluetooth cannot lower the occurrence of traffic accidents caused due to poor physical status of the car driver or motorcycle rider. Further, the muscles may become fatigued or a back pain may occur when car driver or motorcycle rider is keeping in one same posture for a long period. When a car driver or motorcycle rider gets back pain, he or she may be unable to make a proper reaction immediately upon an emergency condition.

Accordingly, there is a strong need for an earphone set that eliminates the aforesaid problem.

### SUMMARY OF THE INVENTION

The present invention has been accomplished under the circumstances in view. It is the main object of the present invention to provide an portable electronic apparatus set with a user physical status sensing and warning circuit, which detects the user's physical status and gives a warning signal to alert the user when the user's physical status is abnormal, avoiding user's muscle fatigue and back pain due to maintenance of one single posture over a long period and preventing occurrence of potential accident.

To achieve this and other objects of the present invention, an portable electronic apparatus set comprises one or two speakers for voice output, a microphone for converting sound into an electrical signal, a wireless transmission module for two-way wireless communication with an external electronic device, and a user physical status sensing and warning circuit. The user physical status sensing and warning circuit comprises a sensor module adapted for sensing the user's physical status, a memory unit having stored therein predetermined configuration status data, an alarm, and a microcontroller for driving the sensor module to detect the user's physical status, comparing the detected physical status data to the configuration status data stored in the memory unit, determining the detected physical status data to be an abnormal physical status when the comparison result matches, and driving the alarm to produce a warning signal when an abnormal physical status is determined.

Alternately, another embodiment to achieve this and other objects of the present invention, a portable electric apparatus comprises one or two speakers for voice output, and a user physical status sensing and warning circuit. The user physical status sensing and warning circuit comprises a sensor module adapted for sensing the user's physical status, a memory unit having stored therein predetermined configuration status data, an alarm, and a microcontroller for driving the sensor module to detect the user's physical status, comparing the detected physical status data to the configuration status data stored in the memory unit, determining the detected physical status data to be an abnormal physical status when the comparison result matches, and driving the alarm to produce a warning signal when an abnormal physical status is determined.

Further, the alarm can be a vibrator for providing a progressive vibration or intermittent vibration, voice generating means for providing bell ringing sound, sharp beeping sound, bird's singing sound, human voice, song or music to wake up the user.

Further, the memory unit comprises a first memory block and a second memory block. The first memory block and the second memory block each have stored therein reference configuration status data. The reference value of the configuration status data stored in the first memory block is greater than that stored in the second memory block. The microcontroller transmits the detected physical status data that is determined to be an abnormal physical status to the memory unit to update the storage configuration status data of the second memory block. This synchronous updating and learning function enables the portable electronic apparatus set to automatically adjust the settings subject to individual habits.

### BRIEF DESCRIPTION OF THE DRAWINGS

FIG. 1 is a system block diagram of a portable electronic apparatus in accordance with the present invention.

FIG. 2 is an operational flow chart of the portable electronic apparatus in accordance with the present invention.

FIG. 3 is a system block diagram of an portable electronic apparatus in accordance with another embodiment of the present invention.

### DETAILED DESCRIPTION OF THE PREFERRED EMBODIMENT

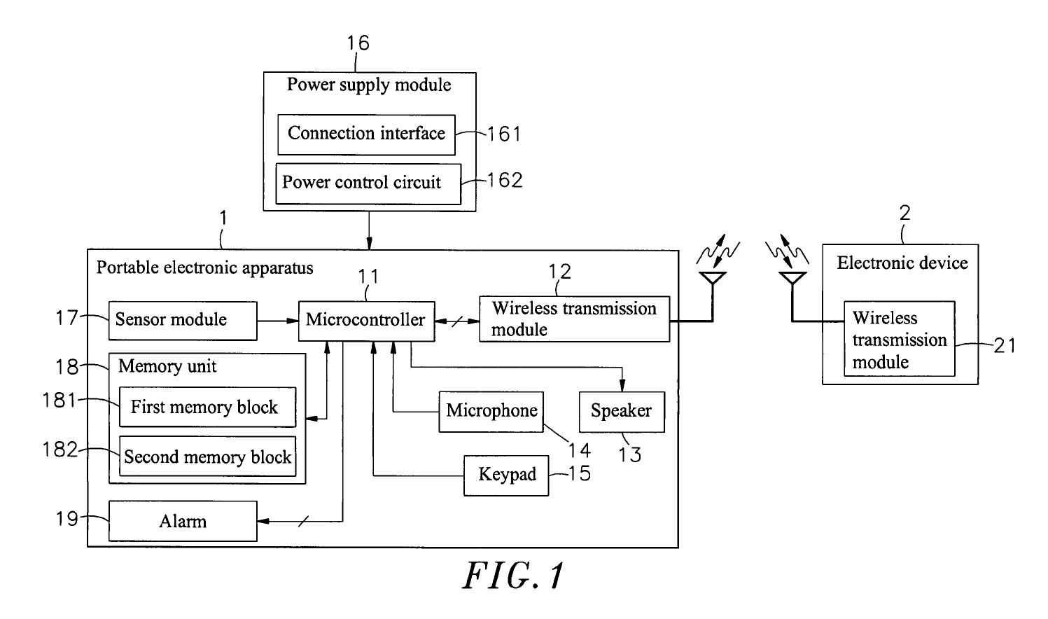

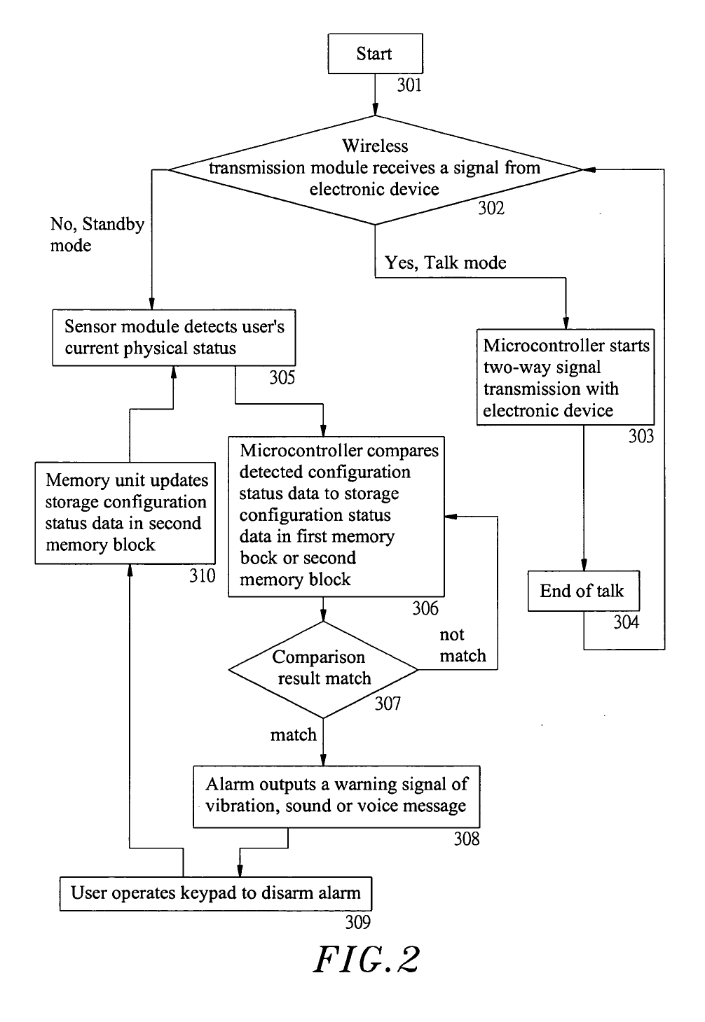

Referring to FIGS. 1 and 2, a portable electronic apparatus 1 in accordance with the present invention comprises a microcontroller 11, a sensor module 17, a memory unit 18 and an alarm 19.

The microcontroller 11 has program and system unit editing and signal communicating and processing functions. Further, the microcontroller 11 is electrically connected with a wireless transmission module 12, two speakers 13, a microphone 14 and a keypad 15. The wireless transmission module 12 can be a Bluetooth, RF, wireless network (Wi-Fi, wireless Lan or ZigBee) or infrared type transmission module. The speakers 13 are electroacoustical transducers that convert an electrical signal to sound. The microphone 14 is an acoustic-to-electric transducer that converts sound into an electrical signal. The keypad 15 comprises a plurality of pushbutton switches, touch switches or mechanical switches for pressing by a user to run a built-in program, to perform editing, or to input voice signals. Further, the portable electronic apparatus 1 has a power supply module 16 built therein or externally connected thereto. The power supply module 16 comprises a connection interface 161 and a power control circuit 162. The power control circuit 162 is electrically connected to the microcontroller 11. The connection interface 161 is connectable to an external power source that converts AC into DC for storing in the power supply module 16. The power control circuit 162 provides internal storage power for the working of the portable electronic apparatus 1. The power supply module 16 can be a storage battery or dry battery.

The sensor module 17 is electrically connected to the microcontroller 11. Further, the sensor module 17 can be a vibration sensor, G-sensor or gyroscope for measuring vibration, acceleration or orientation.

The memory unit 18 is electrically connected to the microcontroller 11 for signal fetching and storing. Further, the memory unit 18 comprises a first memory block 181 and a second memory block 182 that are formed of at least one DRAM/EDO DRAM, SDRAM, SRAM or Flash chip.

The alarm 19 is electrically connected to the microcontroller 11. Further, the alarm 19 can be a vibrator, music generator or voice message generator for providing a warning vibration, sound or voice message to alert the user.

The microcontroller 11 can be an ARM (Advanced RISC Machines) embedded processor, having a pre-programmed or pre-stored software program adapted for reading, judging or comparing the physical status data detected by the sensor module 17. Further, the memory unit 18 can be built in the microcontroller 11, or externally connected to the microcontroller 11. By means of the wireless transmission module 12, the microcontroller 11 can communicate with a wireless transmission module 21 of an external electronic device 2 for signal transmission so that the voice of the user of the electronic device 2 or the internal voice or music data of the electronic device 2 can be outputted through the speakers 13 for hearing by the user of the portable electronic apparatus 1. Further, the user of the portable electronic apparatus 1 can operate the keypad 15 to control start or end of talk, adjustment of volume, editing or operation of input choice, switching of power supply, etc. Further, the external electronic device 2 can be a mobile telephone, PDA, media player (iPod or MP3/MP4 player) or notebook computer.

When in use, the portable electronic apparatus 1 can be switched between a talk mode and a standby mode. The portable electronic apparatus 1 runs subject to the following steps:
(301) Start;
(302) Microcontroller 11 detects whether or not wireless transmission module 12 receives a signal from electronic device 2? And then enters talk mode and proceeds to step
(303) when yes, or enters standby mode and proceeds to step (305) when not;
(303) Microcontroller 11 starts two-way signal (user voice or music data) transmission with electronic device 2;
(304) Return to step (302) after end of talk;
(305) Microcontroller 11 drives sensor module 17 to detect user's current physical status (one single posture over a predetermined period, poor spiritual status or sleeping status);
(306) Microcontroller 11 compares configuration status data detected by sensor module 17 to storage configuration status data in first memory bock 181 or second memory block 182 of memory unit 18;
(307) Return to step (306) when the comparison does not match, or proceed to step (308) when the comparison matches;
(308) Alarm 19 outputs a warning signal of vibration, sound or voice message;
(309) User operates keypad 15 to disarm alarm 19; and
(310) Memory unit 18 updates storage configuration status data in second memory block 182, and then return to step (305).

As indicated in the aforesaid operation flow, when using the portable electronic apparatus 1, the portable electronic apparatus 1 is positively secured to the user's head or ears. At this time, the user can operate the keypad 15 to switch on the power supply module 16 and to start up the portable electronic apparatus 1, enabling the microcontroller 11 to detect whether or not the wireless transmission module 12 receives a signal (user's voice, music, recorded voice message) from an electronic device 2? When the wireless transmission module 12 is receiving a signal, the portable electronic apparatus enters the talk mode, and the microcontroller 11 makes a two-way communication with the electronic device 2. The microcontroller 11 cuts off the electronic device 2 immediately after end of talk to avoid any potential accident due to user's unconcentration or mistake. If the wireless transmission modules 12 receives no signal, the portable electronic apparatus enters the standby mode, and the microcontroller 11 drives the sensor module 17 (G-sensor) to continuously detect the user's physical status, and compares the configuration status data obtained from the sensor module 17 to the configuration status data stored in the first memory block 181 (the configuration status data in the first memory block 181 is preset in factory; the reference value of the configuration status data stored in the first memory block 181 is greater than that stored in the second memory block 182. For example, when the user's head is immovable over 10 seconds (counts once), 15˜25 seconds (counts twice) or 25 seconds (counts triple), the microcontroller 11 compares this detection data to the storage configuration status data and determines the user's physical status subject to the comparison result. When the comparison matches, the user's physical status is regarded as abnormal. Abnormal physical status includes immovability of user's head over a predetermined period that is regarded as one single posture over a predetermined period, and inclination or rotation of user's head over a predetermined angle that is regarded as a poor spiritual status or sleeping status. When an abnormal physical status is detected, the microcontroller 11 drives the alarm 19 to give a warning signal of vibration, sound or voice message, thereby alerting the user to concentrate the attention so as to avoid muscle fatigue and back pain due to maintenance of one single posture over a long period and to prevent occurrence of potential accident.

Further, the user can operate the keypad 15 to disarm the alarm 19 manually. Disarming the alarm 19 manually instead of an auto disarm design avoids stopping of the alarm 19 before waking up the user. The warning signal produced by the alarm 19 can be a sound (bell ringing sound, sharp beeping sound, bird's singing sound, etc.), a voice message (human voice, song or music), a progressive vibration or an intermittent vibration. The system can also be designed to disarm the alarm 19 automatically by means of detection of a dynamic posture (such as shaking the head, twisting the neck, etc.) of the user by the sensor module 17. After giving a warning signal, the microcontroller 11 stores the detected physical status data to the memory unit 18 to update the storage configuration status data of the second memory block 182 so that the microcontroller 11 can compare a further detection data to the updated configuration status data in the second memory block 182 of the memory unit 18 directly in a next operation without through the first memory block 181. This synchronous updating and learning function enables the system to automatically adjust the settings subject to individual habits.

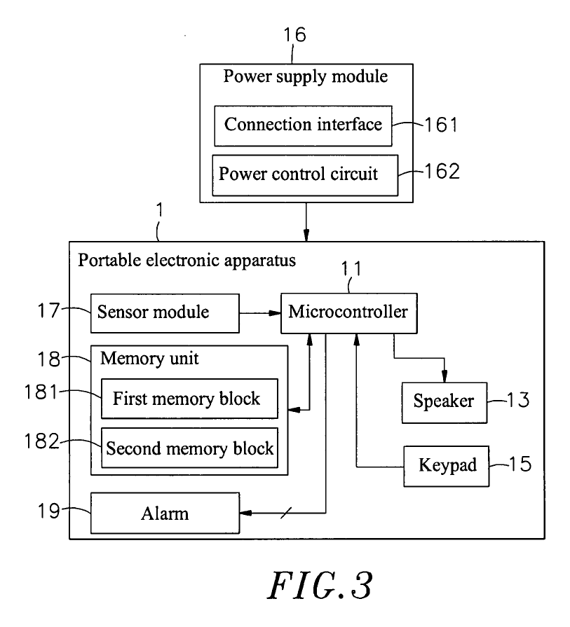

Alternately, referring to FIG. 3, a portable electric apparatus in accordance with another embodiment of the present invention is present. The portable electric apparatus 1 includes a microcontroller 11, a sensor module 17, a memory unit 18 and an alarm 19. The microcontroller 11 is respectably electrically connected with two speakers 13, a keypad 15, the sensor module 17, the memory unit 18, and the alarm 19. The portable electronic apparatus 1 has a power supply module 16 built therein or externally connected thereto.

As indicated in the aforesaid operation flow, when using the portable electronic apparatus 1, the portable electronic apparatus 1 is positively secured to the user's head or ears. At this time, the user can operate the keypad 15 to switch on the power supply module 16 and to start up the portable electronic apparatus 1, enabling the microcontroller 11 drives the sensor module 17 (G-sensor) to continuously detect the user's physical status, and compares the configuration status data obtained from the sensor module 17 to the configuration status data stored in the first memory block 181 (the configuration status data in the first memory block 181 is preset in factory; the reference value of the configuration status data stored in the first memory block 181 is greater than that stored in the second memory block 182. For example, when the user's head is immovable over 10 seconds (counts once), 15˜25 seconds (counts twice) or 25 seconds (counts triple), the microcontroller 11 compares this detection data to the storage configuration status data and determines the user's physical status subject to the comparison result. When the comparison matches, the user's physical status is regarded as abnormal. Abnormal physical status includes immovability of user's head over a predetermined period that is regarded as one single posture over a predetermined period, and inclination or rotation of user's head over a predetermined angle that is regarded as a poor spiritual status or sleeping status. When an abnormal physical status is detected, the microcontroller 11 drives the alarm 19 to give a warning signal of vibration, sound or voice message, thereby alerting the user to concentrate the attention so as to avoid muscle fatigue and back pain due to maintenance of one single posture over a long period and to prevent occurrence of potential accident.

Although a particular embodiment of the invention has been described in detail for purposes of illustration, various modifications and enhancements may be made without departing from the spirit and scope of the invention. For example, the memory unit 18 can have only the first memory block 181 that has factory-set reference configuration status data stored therein, so that the microcontroller 11 can store a detected physical status data from the sensor module 17 to the memory unit 18 to update the storage configuration status data of the first memory block 181. Accordingly, the invention is not to be limited except as by the appended claims.

What the invention claimed is:

1. An portable electronic apparatus, comprising at least one speaker for voice output, a microphone for converting sound into an electrical signal, a wireless transmission module for two-way wireless communication with an external electronic device, and a user physical status sensing and warning circuit, wherein said user physical status sensing and warning circuit comprises:
a sensor module adapted for sensing the physical status of a user using the portable electronic apparatus;
a memory unit having stored therein predetermined configuration status data;
an alarm controllable to produce a warning signal; and
a microcontroller electrically connected with said at least one speaker, said wireless transmission module, said microphone, said sensor module, said memory unit and said alarm, said microcontroller being adapted for driving said sensor module to detect the physical status of the user, comparing the detected physical status data to the configuration status data stored in said memory unit, determining the detected physical status data to be an abnormal physical status when the comparison result matches, and driving said alarm to produce a warning signal when an abnormal physical status is determined.

2. The portable electronic apparatus as claimed in claim 1, wherein said microcontroller is an ARM (Advanced RISC Machines) embedded processor, having a built-in software program adapted for reading, judging and comparing the physical status data detected by said sensor module.

3. The portable electronic apparatus as claimed in claim 1, further comprising a keypad electrically connected to said microcontroller, said keypad comprising a plurality of switch means operable by the user to run a program built in said microcontroller, to perform editing and to input voice signals selectively.

4. The portable electronic apparatus as claimed in claim 1, further comprising a power supply module to provide the portable electronic apparatus with the necessary working voltage, said power supply module comprising a connection interface connectable to an external power source and a power control circuit electrically connected to said microcontroller for controlling input of an external power supply and output of internal storage power supply to said microcontroller.

5. The portable electronic apparatus as claimed in claim 1, wherein said wireless transmission module is selected from a group of Bluetooth, RF (radio frequency), Wi-Fi, wireless LAN (local area network), ZigBee and infrared type transmission modules.

6. The portable electronic apparatus as claimed in claim 1, wherein said sensor module is selected from a group of vibration sensors, G-sensors and gyroscopes.

7. The portable electronic apparatus as claimed in claim 1, wherein said memory unit comprises at least one first memory block, each said first memory block having stored therein predetermined configuration status data; said microcontroller transmits the detected physical status data being determined to be an abnormal physical status to one said first memory block to update the storage configuration status data.

8. The portable electronic apparatus as claimed in claim 1, wherein each said first memory block of said memory unit is selected from a memory group of DRAM/EDO DRAM, SDRAM, SRAM and Flash chip.

9. The portable electronic apparatus as claimed in claim 1, wherein said memory unit comprises at least one first memory block and at least one second memory block, said at least one first memory block and said at least one second memory block each having stored therein reference configuration status data, the reference value of the configuration status data stored in said at least one first memory block being greater than that stored in said at least one second memory block; said microcontroller transmits the detected physical status data being determined to be an abnormal physical status to said memory unit to update the storage configuration status data of said at least one second memory block.

10. The portable electronic apparatus as claimed in claim 1, wherein each said first memory block and said second memory block of said memory unit are respectively selected from a memory group of DRAM/EDO DRAM, SDRAM, SRAM and Flash chip.

11. The portable electronic apparatus as claimed in claim 1, wherein said abnormal physical status includes immovability of the head of the user over a predetermined period that is regarded as maintenance of one single posture over a predetermined period, inclination of the head of the user over a predetermined angle, and rotation of the head of the user over a predetermined angle.

12. The portable electronic apparatus as claimed in claim 1, wherein said alarm is selected from a group of vibrator, music generator and voice message generator.

13. An portable electronic apparatus, comprising at least one speaker for voice output, and a user physical status sensing and warning circuit, wherein said user physical status sensing and warning circuit comprises:
a sensor module adapted for sensing the physical status of a user using the portable electronic apparatus;
a memory unit having stored therein predetermined configuration status data;
an alarm controllable to produce a warning signal; and
a microcontroller electrically connected with said at least one speaker, said sensor module, said memory unit and said alarm, said microcontroller being adapted for driving said sensor module to detect the physical status of the user, comparing the detected physical status data to the configuration status data stored in said memory unit, determining the detected physical status data to be an abnormal physical status when the comparison result matches, and driving said alarm to produce a warning signal when an abnormal physical status is determined.

14. The portable electronic apparatus as claimed in claim 13, wherein said microcontroller is an ARM (Advanced RISC Machines) embedded processor, having a built-in software program adapted for reading, judging and comparing the physical status data detected by said sensor module.

15. The portable electronic apparatus as claimed in claim 13, further comprising a keypad electrically connected to said microcontroller, said keypad comprising a plurality of switch means operable by the user to run a program built in said microcontroller, to perform editing and to input voice signals selectively.

16. The portable electronic apparatus as claimed in claim 13, wherein said sensor module is selected from a group of vibration sensors, G-sensors and gyroscopes.

17. The portable electronic apparatus as claimed in claim 13, wherein said memory unit comprises at least one first memory block, each said first memory block having stored therein predetermined configuration status data; said microcontroller transmits the detected physical status data being determined to be an abnormal physical status to one said first memory block to update the storage configuration status data.

18. The portable electronic apparatus as claimed in claim 13, wherein said memory unit comprises at least one first memory block and at least one second memory block, said at least one first memory block and said at least one second memory block each having stored therein reference configuration status data, the reference value of the configuration status data stored in said at least one first memory block being greater than that stored in said at least one second memory block; said microcontroller transmits the detected physical status data being determined to be an abnormal physical status to said memory unit to update the storage configuration status data of said at least one second memory block.

19. The portable electronic apparatus as claimed in claim 13, wherein said abnormal physical status includes immovability of the head of the user over a predetermined period that is regarded as maintenance of one single posture over a predetermined period, inclination of the head of the user over a predetermined angle, and rotation of the head of the user over a predetermined angle.

20. The portable electronic apparatus as claimed in claim 13, wherein said alarm is selected from a group of vibrator, music generator and voice message generator.
